(19) United States
(12) Patent Application Publication
(10) Pub. No.: US 2023/0337331 A1
(43) Pub. Date: Oct. 19, 2023

(54) CONDUCTIVE STRUCTURE, MANUFACTURING METHOD FOR CONDUCTIVE STRUCTURE, ARTICLE INCLUDING CONDUCTIVE STRUCTURE, AND MANUFACTURING METHOD FOR ARTICLE INCLUDING CONDUCTIVE STRUCTURE

(71) Applicant: LINTEC Corporation, Tokyo (JP)

(72) Inventors: Tatsuki HASEGAWA, Tokyo (JP); Kenta NISHIJIMA, Tokyo (JP); Takashi MORIOKA, Tokyo (JP)

(73) Assignee: LINTEC Corporation, Tokyo (JP)

(21) Appl. No.: 18/028,976

(22) PCT Filed: Sep. 29, 2021
(86) PCT No.: PCT/JP2021/035779

§ 371 Date: Mar. 28, 2023

(30) Foreign Application Priority Data
Sep. 29, 2020 (JP) 2020-163555

(51) Int. Cl. H05B 3/14; H05B 3/26

(52) U.S. Cl. CPC H05B 3/146; H05B 3/267

(57) ABSTRACT

Provided are a conductive structure having low contact resistance, the conductive structure including a cured layer formed by curing a curable composition, a conductive linear body fixed by the cured layer, and a pair of electrodes placed so as to directly contact the conductive linear body, wherein the curable composition contains a cationic polymerizable compound and a photocationic polymerization initiator, and the cured layer fixes the electrodes; a manufacturing method for the conductive structure; and article including the conductive structure; and a manufacturing method for the article.

### TECHNICAL FIELD

The present disclosure relates to a conductive structure, a manufacturing method for the conductive structure, an article including the conductive structure, and a manufacturing method for the article including the conductive structure.

### BACKGROUND ART

In recent years, proposals have been made for using, as a heat-generating element of a heat generator, a conductive structure obtained by fixing a conductive member such as metal wire or the like to a support body.

For example, Patent Literature 1 describes a sheet (hereinafter also referred to as “conductive sheet”) having a pseudo-sheet structure obtained by arranging, at intervals, a plurality of conductive linear bodies that extend in one direction. Patent Literature 1 also indicates that the conductive sheet can be used as the heat-generating element of various types of heat generators by joining, using solder or the like, an electricity supply part (hereinafter also referred to as “electrode”) to both ends of the conductive linear bodies of the conductive sheet.

### CITATION LIST

### Patent Literature

Patent Literature 1: International Publication No. WO 2017/086395 (US2018/0326697A1)

### SUMMARY OF INVENTION

### Technical Problem

As described in Patent Literature 1, a conductive structure having low contact resistance can be obtained by reliably joining the conductive linear bodies and the electrodes using a conductive joining material such as solder or the like.

However, from the perspective of enhancing production efficiency, it is preferable that the conductive linear bodies and the electrode be electrically connected by a simpler method without using a conductive joining material such as solder or the like.

The present disclosure is made with the view of the above situation, and an objective of the present disclosure is to provide a conductive structure including a conductive linear body and a pair of electrodes directly contacting the conductive linear body, the conductive structure having low contact resistance; a manufacturing method for the conductive structure; an article including the conductive structure; and a manufacturing method for the article.

In the present disclosure, the phrase “directly contacting the conductive linear body” means that the conductive linear body and the electrodes are electrically connected to each other without a conductive joining material such as solder or the like being provided therebetween.

### Solution to Problem

To achieve the objective described above, the present inventors diligently studied a conductive structure including a conductive linear body and a pair of electrodes directly contacting the conductive linear body.

As a result, the present inventors discovered the following and completed the present disclosure:
1) A conductive structure having low contact resistance can be obtained without using a conductive joining material such as solder or the like by placing the electrodes so as to directly contact the conductive linear body and, while maintaining this state, reliably fixing the conductive linear body and the electrodes, respectively; and
2) A curable composition containing a cationic polymerizable compound and a photocationic polymerization initiator is very suitable as a fixing agent for fixing the conductive linear body and the electrodes.

According to the present disclosure, the following conductive structure of [1] to [10], the manufacturing method for the conductive structure of [11] and [12], the article of [13], and the manufacturing method for the article of [14] are provided.

[1] A conductive structure comprising: a cured layer formed by curing a curable composition; a conductive linear body fixed by the cured layer; and a pair of electrodes placed so as to directly contact the conductive linear body, wherein
the curable composition contains a cationic polymerizable compound and a photocationic polymerization initiator, and
the cured layer fixes the electrodes.

The conductive structure according to [1], wherein the cationic polymerizable compound is a compound that includes a cyclic ether group.

The conductive structure according to [1] or [2], wherein the conductive linear body has a wave-like shape.

The conductive structure according to any of [1] to [3], wherein the conductive linear body includes a metal wire.

The conductive structure according to any of [1] to [4], comprising:
two or more of the conductive linear bodies, wherein
a pseudo-sheet structure is formed by arranging the two or more of the conductive linear bodies at an interval.

The conductive structure according to any of [1] to [5], wherein the electrodes are metal wires or metal foils.

The conductive structure according to any of [1] to [6], further comprising:
a first support adjacent to a side of the cured layer on which the electrodes are not provided, wherein
a light transmittance at a wavelength of 365 nm of the first support is 50% or less.

The conductive structure according to any of [1] to [7], further comprising a second support adjacent to a side of the cured layer on which the electrodes are provided, wherein a light transmittance at a wavelength of 365 nm of the second support is 50% or less.

The conductive structure according to [7] or [8], wherein at least one of the first support or the second support is a polyimide film.

The conductive structure according to any of [7] to [9], wherein at least one of the first support or the second support is a non-woven fabric or a woven fabric.

A manufacturing method for the conductive structure according to any of [8] to [10], comprising:
a first step of manufacturing a manufacturing intermediate including a curable composition layer that is a coating of a curable composition that contains a cationic polymerizable compound and a photocationic polymerization initiator, a conductive linear body temporarily fixed by the curable composition layer, and a pair of electrodes placed so as to directly contact the conductive linear body;
a second step of irradiating light on the curable composition layer in the manufacturing intermediate, after the first step; and
a third step of affixing the curable composition layer irradiated with the light to a support, after the second step.

The manufacturing method for the conductive structure according to any of [8] to [10], comprising:
a first step of manufacturing a manufacturing intermediate including a curable composition layer that is a coating of a curable composition that contains a cationic polymerizable compound and a photocationic polymerization initiator, and a conductive linear body temporarily fixed by the curable composition layer;
a second step of irradiating light on the curable composition layer in the manufacturing intermediate, after the first step;
a third step of placing a pair of electrodes on the conductive linear body so as to directly contact the conductive linear body, after the second step; and
a fourth step of affixing the curable composition layer irradiated with the light to a support, after the third step.

An article comprising the conductive structure according to any of [1] to [10].

A manufacturing method for the article according to [13], comprising:
a first step of manufacturing a manufacturing intermediate including a curable composition layer that is a coating of a curable composition that contains a cationic polymerizable compound and a photocationic polymerization initiator, a conductive linear body temporarily fixed by the curable composition layer, and a pair of electrodes placed so as to directly contact the conductive linear body;
a second step of irradiating light on the curable composition layer in the manufacturing intermediate, after the first step; and
a third step of affixing the curable composition layer irradiated with the light to an adherend article, after the second step.

### Advantageous Effects of Invention

According to the present disclosure, a conductive structure including a conductive linear body and a pair of electrodes directly contacting the conductive linear body, the conductive structure having low contact resistance; a manufacturing method for the conductive structure; an article including the conductive structure; and a manufacturing method for the article are provided.

### BRIEF DESCRIPTION OF DRAWINGS

FIG. 1 is a schematic drawing illustrating a conductive structure according to an embodiment of the present disclosure;

FIG. 2 is a schematic drawing illustrating a cross-section of FIG. 1, taken along line A-A;

FIG. 3 is a schematic drawing illustrating a cross-section of FIG. 1, taken along line B-B;

FIG. 4 is a schematic drawing illustrating a conductive structure according to an embodiment of the present disclosure;

FIG. 5 is a schematic drawing illustrating a conductive structure according to an embodiment of the present disclosure;

FIG. 6 is a schematic drawing illustrating a conductive structure according to an embodiment of the present disclosure;

FIG. 7 is a schematic drawing illustrating a conductive structure according to an embodiment of the present disclosure;

FIG. 8 is a schematic drawing illustrating a cross-section of FIG. 7, taken along line C-C;

FIG. 9 is a schematic drawing illustrating a cross-section of FIG. 7, taken along line D-D;

FIG. 10 is a schematic drawing illustrating a cross-section of FIG. 7, taken along line E-E; and

FIG. 11 is a schematic drawing illustrating a conductive structure according to an embodiment of the present disclosure.

### DESCRIPTION OF EMBODIMENTS

Hereinafter, the present disclosure is divided into the following sections and described in detail:
1) A conductive structure and a manufacturing method for the conductive structure, and
2) An article including the conductive structure, and a manufacturing method for the article.

### 1) Conductive Structure and Manufacturing Method for the Conductive Structure

The conductive structure of the present disclosure includes a cured layer formed by curing a curable composition; a conductive linear body fixed by the cured layer; and a pair of electrodes placed so as to directly contact the conductive linear body, wherein the curable composition contains a cationic polymerizable compound and a photocationic polymerization initiator, and the cured layer fixes the electrodes.

The structure of the conductive structure of the present disclosure is described while referencing the drawings. It should be noted that some parts are illustrated on an enlarged scale or a reduced scale, and some curved lines and curved planes are illustrated as straight lines and flat planes in the drawings for the convenience of explanation.

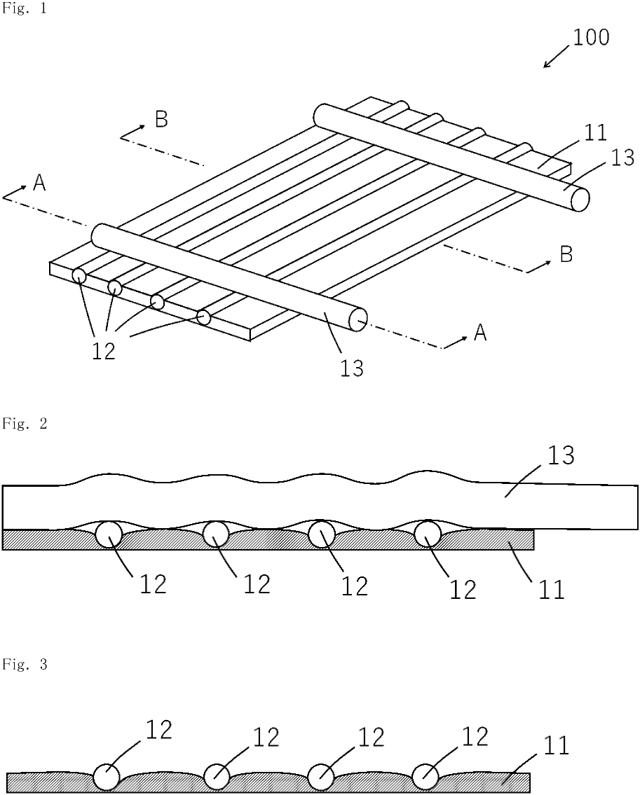

A conductive structure 100 illustrated in FIG. 1 includes a cured layer 11, conductive linear bodies 12, and a pair of electrodes 13.

FIG. 2 is a schematic drawing illustrating a cross-section of FIG. 1, taken along line A-A, and FIG. 3 is a schematic drawing illustrating a cross-section of FIG. 1, taken along line B-B.

As illustrated in FIGS. 2 and 3, the conductive linear bodies 12 are fixed by the cured layer 11. The electrodes 13 directly contact the conductive linear bodies 12. The cured layer 11 is thinner than the diameter of the electrodes 12 and, as such, the components of the cured layer 11 do not enter between the electrodes 13 and the conductive linear bodies 12 and obstruct the electrical connection between the electrodes 13 and the conductive linear bodies 12. However, the electrodes 13 are deformable and, as such, the electrodes 13 partially contact the cured layer 11 and are directly fixed by the cured layer 11.

In the conductive structure of the present disclosure, the positional relationships between the cured layer, the conductive linear bodies, and the pair of electrodes are not limited to those illustrated in FIG. 1.

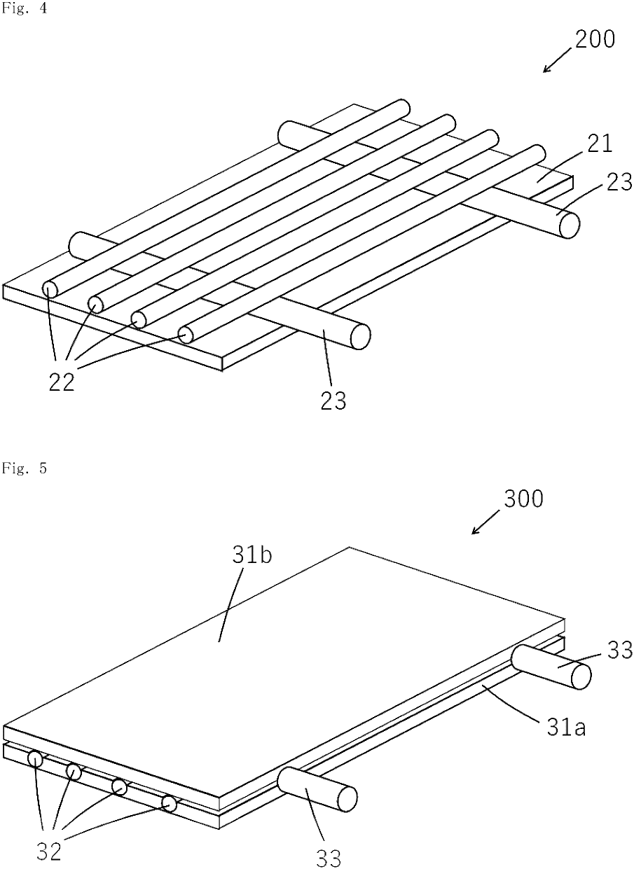

For example, in a conductive structure 200 illustrated in FIG. 4, a cured layer 21 exists on the side of conductive linear bodies 22 on which a pair of electrodes 23 is provided.

The cured layer 21 contacts and fixes the conductive linear bodies 22 and the pair of electrodes 23.

The conductive structure of the present disclosure may include a second cured layer.

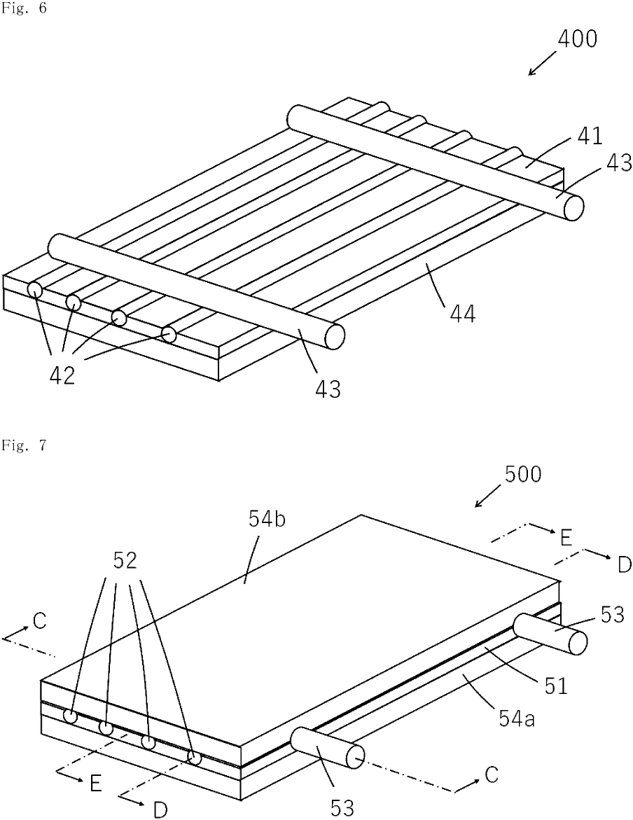

For example, in a conductive structure 300 illustrated in FIG. 5, a second cured layer 31b is provided on an upper surface portion of a conductive structure that has the same structure as the conductive structure 100 and that includes a first cured layer 31a, conductive linear bodies 32, and a pair of electrodes 33.

The first cured layer 31a and the second cured layer 31b contact and fix the conductive linear bodies 32 and the pair of electrodes 33.

The first cured layer 31a and the second cured layer 31b may be formed from the same components, or may be formed from different components.

Note that, when the conductive structure includes two cured layers, the cured layer disposed such that the surface formed by the conductive linear bodies is closer than the surface formed by the pair of electrodes is referred to as the “first cured layer”, and the cured layer disposed such that the surface formed by the conductive linear bodies is farther than the surface formed by the pair of electrodes is referred to as the “second cured layer.”

As described later, the conductive structure of the present disclosure may include a support.

A conductive structure 400 illustrated in FIG. 6 includes a cured layer 41, conductive linear bodies 42, and a pair of electrodes 43, and further includes a support 44 adjacent to the side of the cured layer 41 on which the electrodes 43 are not provided.

Note that, when the conductive structure includes two supports, the support disposed such that the surface formed by the conductive linear bodies is closer than the surface formed by the pair of electrodes is referred to as the “first support”, and the support disposed such that the surface formed by the conductive linear bodies is farther than the surface formed by the pair of electrodes is referred to as the “second support.”

A conductive structure 500 illustrated in FIG. 7 includes a cured layer 51, conductive linear bodies 52, and a pair of electrodes 53, and further includes a first support 54a and a second support 54b.

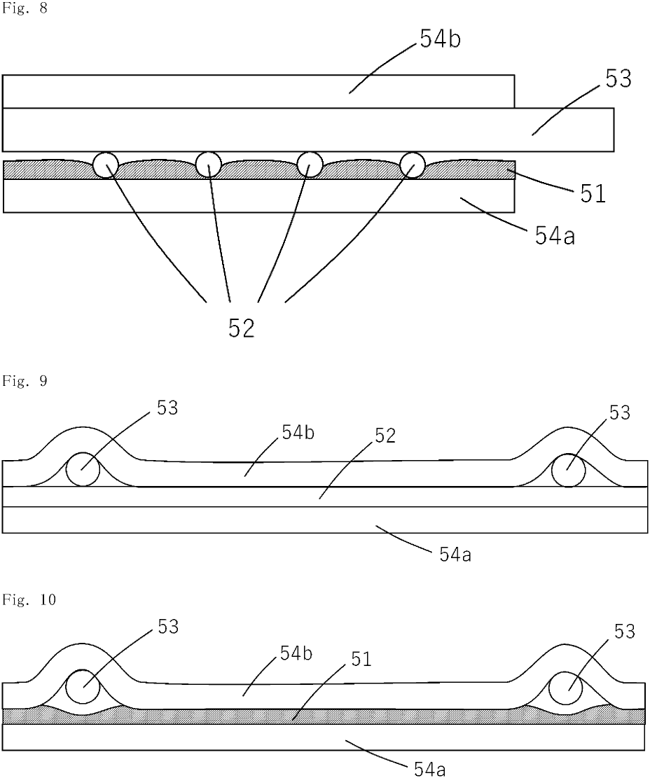

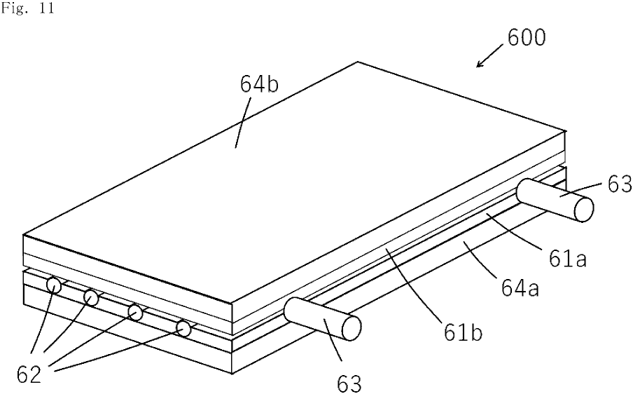

FIG. 8 is a schematic drawing illustrating a cross-section of FIG. 7, taken along line C-C, FIG. 9 is a schematic drawing illustrating a cross-section of FIG. 7, taken along line D-D, and FIG. 10 is a schematic drawing illustrating a cross-section of FIG. 7, taken along line E-E.

As in the embodiment illustrated in FIGS. 7 to 10, a configuration is possible in which the electrodes 53 do not contact the cured layer 51. In such a case, the electrodes 53 are not directly fixed by the cured layer 51. However, when the first support 54a and the second support 54b are both substrates that are inseparable from the cured layer 51, the cured layer 51 adheres the first support 54a and the second support 54b to each other, and the electrodes 53 are subjected to pressure from above and beneath. Thus, the electrodes 53 are indirectly fixed by the cured layer 51.

From the perspectives of reliably fixing the conductive linear bodies and the electrodes, and reducing the contact resistance of the conductive linear bodies, it is preferable that, as with the conductive structure 500, the electrodes 53 contact the cured layer 51 and the cured layer 51 directly fixes the electrodes 53, even when the first support (substrate) 54a and the second support (substrate) 54b are provided.

A conductive structure 600 illustrated in FIG. 11 includes a first cured layer 61a and a second cured layer 61b, conductive linear bodies 62, and a pair of electrodes 63, and further includes a first support 64a and a second support 64b.

The first cured layer 61a and the second cured layer 61b may be formed from the same components, or may be formed from different components.

A laminate having a laminated structure obtained by removing the first cured layer 61a from the conductive structure 600 is also a conductive structure of the present disclosure. In this conductive structure, the conductive linear bodies 62 and the electrodes 63 are fixed by the second cured layer 61b.

Hereinafter, the various members of the conductive structure of the present disclosure are described.

### Cured Layer

The cured layer of the conductive structure of the present disclosure is formed by curing a curable composition containing a cationic polymerizable compound and a photocationic polymerization initiator.

By forming the cured layer using this curable composition, the conductive linear bodies and the electrodes can be reliably fixed, and the contact resistance of the conductive structure can be reduced.

A storage modulus at 23° C. of the cured layer is preferably from 0.5×10⁷ to 1.0×10¹⁰ Pa, more preferably from 0.8×10⁷ to 8.0×10⁹ Pa, and even more preferably from 1.0×10⁷ to 5.0×10⁹ Pa.

As a result of the storage modulus at 23° C. of the cured layer being in these ranges, the conductive linear bodies and the electrodes can be reliably fixed and the occurrence of failures when the flexible conductive linear bodies are deformed can be suppressed.

A thickness of the cured layer is preferably from 5 to 75 µm, more preferably from 8 to 60 µm, and even more preferably from 12 to 40 µm.

Note that it is preferable that the cured layer is thinner than the value of the diameter of the conductive linear bodies. As a result of the cured layer being thinner than the value of the diameter of the conductive linear bodies, when the conductive linear bodies are embedded in the cured layer as in the conductive structure 100, the curable composition is less likely to enter between the electrodes and the conductive linear bodies, and rises in the contact resistance between the electrodes and the conductive linear bodies are suppressed.

As such, the thickness of the cured layer is preferably 0.95 times the diameter of the conductive linear bodies or less, and is more preferably 0.9 times the diameter of the conductive linear bodies or less. Additionally, the thickness of the cured layer is preferably 0.5 times the diameter of the conductive linear bodies or greater, and is more preferably 0.6 times the diameter of the conductive linear bodies or greater.

The curable composition used in the forming of the cured layer contains a cationic polymerizable compound and a photocationic polymerization initiator.

The cationic polymerizable compound contained in the curable composition is a compound that becomes a polymer by a cationic polymerization reaction.

The conductive linear bodies and the electrodes can be reliably fixed by curing the curable composition containing the cationic polymerizable compound.

The cationic polymerizable compound is preferably a compound that is a liquid at 25° C. As a result of using the cationic polymerizable compound that is a liquid at 25° C., it is easier to obtain a curable composition with excellent tackiness.

The phrase “liquid at 25° C.” means being fluid at 25° C. The viscosity of the cationic polymerizable compound, measured at 25° C. and 1.0 RPM using an E-type viscometer, is preferably from 2 to 10,000 mPa·s.

The molecular weight of the cationic polymerizable compound is typically from 100 to 5,000, and is preferably from 200 to 4,000.

A content of the cationic polymerizable compound in the curable composition is preferably from 20 to 80 mass%, is more preferably from 25 to 70 mass%, and is even more preferably from 30 to 65 mass% with respect to all components, except the solvent, in the curable composition.

Adjusting of the adhesion of the curable composition after being irradiated with ultraviolet light is facilitated due to the content of the cationic polymerizable compound being in these ranges.

Examples of the cationic polymerizable compound include compounds having a cyclic ether group, compounds having a vinyl ether group, and the like. Among these, since the conductive linear bodies and the electrodes can be more reliably fixed, the compound having a cyclic ether group is preferable as the cationic polymerizable compound.

The compound having a cyclic ether group is referred to as a compound having one or more cyclic ether groups in the molecule.

Examples of the cyclic ether group include an oxirane group (epoxy group), an oxetane group (oxetanyl group), a tetrahydrofuryl group, a tetrahydropyranyl group, and the like.

Since the conductive linear bodies and the electrodes can be more reliably fixed, a compound having an oxirane group or an oxetane group is preferable, and a compound having two or more of an oxirane group or an oxetane group in the molecule is more preferable as the compound having a cyclic ether group.

Examples of the compound having an oxirane group in the molecule include aliphatic epoxy compounds (excluding alicyclic epoxy compounds), aromatic epoxy compounds, alicyclic epoxy compounds, and the like.

Examples of the aliphatic epoxy compound include 1,4-butanediol diglycidyl ether, neopentyl glycol diglycidyl ether, triglycidyl ether of glycerin, triglycidyl ether of trimethylolpropane, tetraglycidyl ether of sorbitol, hexaglycidyl ether of dipentaerythritol, diglycidyl ether of polyethylene glycol, diglycidyl ether of polypropylene glycol, and the like.

Examples of the aromatic epoxy compound include bisphenol A, bisphenol F, or glycidyl etherified products or epoxy novolak resins obtained by adding alkylene oxide thereto; polyglycidyl etherified products of aromatic compounds having two or more phenolic hydroxyl groups such as resorcinol, hydroquinone and catechol; glycidyl etherified products of aromatic compounds having two or more alcoholic hydroxyl groups such as phenyldimethanol, phenyldiethanol, and phenyldibutanol; glycidyl esters of polybasic aromatic compounds having two or more carboxylic acids such as phthalic acid, terephthalic acid, and trimellitic acid; and the like.

Examples of the alicyclic epoxy compound include dicyclopentadiene dimethanol diglycidyl ether, a polyglycidyl etherified product of a polyhydric alcohol having at least one or more alicyclic structures such as a hydrogenated product of bisphenol A, and the like, or cycloalkene oxide compounds such as cyclohexene oxide and cyclopentene oxide-containing compounds obtained by epoxidizing, with an oxidizing agent, cyclohexene or cyclopentene ring-containing compounds.

Examples of the compound having an oxetane group in the molecule include bifunctional aliphatic oxetane compounds such as 3,7-bis(3-oxetanyl)-5-oxa-nonane, 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, 1,4-bis(3-ethyl-3-oxetanylmethoxy)butane, 1,6-bis(3-ethyl-3-oxetanylmethoxy)hexane, and the like; monofunctional oxetane compounds such as 3-ethyl-3-[(phenoxy)methyl]oxetane, 3-ethyl-3-(hexyloxymethyl)oxetane, 3-ethyl-3-(2-ethylhexyloxymethyl)oxetane, 3-ethyl-3-(hydroxymethyl)oxetane, 3-ethyl-3-(chloromethyl)oxetane, and the like; and the like.

A single type of the compound having a cyclic ether group can be used, or two or more types of the compound having a cyclic ether group can be combined and used.

A cyclic ether equivalent of the compound having a cyclic ether group is preferably from 100 g/eq to 500 g/eq, and more preferably from 115 g/eq to 300 g/eq.

As a result of the cyclic ether equivalent of the compound having a cyclic ether group being in these ranges, it is easier to obtain a curable composition with excellent curability.

The term “cyclic ether equivalent” in the present disclosure refers to a value obtained by dividing the molecular weight by the number of cyclic ether groups.

The photocationic polymerization initiator contained in the curable composition is a compound that produces cation species as a result of being irradiated with ultraviolet rays, and initiates a curing reaction of the cationic polymerizable compound. This photocationic polymerization initiator includes a cation portion that absorbs the ultraviolet rays and an anion portion that is an acid generation source.

In the present disclosure the conductive linear bodies and the electrodes can be more reliably fixed by curing the curable composition containing the photocationic polymerization initiator.

That is, with a curable composition containing a photoradical polymerization initiator, there is a tendency for the curing reaction to complete in a short amount of time and, consequently, use methods of the curable composition containing the photoradical polymerization initiator are typically limited to those in which a laminate including a curable composition layer is formed and, then, light is irradiated on that curable composition layer to cure the curable composition layer.

Accordingly, when the conductive structure includes a support through which light does not easily transmit, or when the electrodes of the conductive structure are wide, the light cannot sufficiently reach the curable composition layer, the curing of the curable composition layer is insufficient, and it may not be possible to reliably fix the conductive linear bodies and the electrodes.

On the other hands, the curable composition containing the photocationic polymerization initiator requires a certain amount of time for the curing reaction to complete and, as such, the electrodes and the support can be placed after initiating the curing reaction. As a result, light can be irradiated on the entire surface of the curable composition layer before placing the electrodes and the support, and the curable composition layer can be sufficiently cured.

Additionally, with the curable composition used in the present disclosure, the polymerization reaction is not initiated by heat and, as such, the conductive structure can be manufactured without applying an excessive heat load.

Examples of the photocationic polymerization initiator include sulfonium salt compounds, iodonium salt compounds, phosphonium salt compounds, ammonium salt compounds, diazonium salt compounds, selenium salt compounds, oxonium salt compounds, and the like. Among these, since compatibility with other components is excellent, the sulfonium salt compounds are preferable, and aromatic sulfonium salt compounds having an aromatic group are more preferable.

Examples of the sulfonium salt compounds include triphenylsulfonium hexafluorophosphate, triphenylsulfonium hexafluoroantimonate, triphenylsulfonium tetrakis(pentafluorophenyl)borate, 4,4′-bis[diphenylsulfonio]diphenylsulfide-bishexafluorophosphate, 4,4′-bis[di(β-hydroxyethoxy)phenylsulfonio]diphenylsulfide-bishexafluoroantimonate, 7-[di(p-toluyl)sulfonio]-2-isopropylthioxanthone hexafluorophosphate, 7-[di(p-toluyl)sulfonio]-2-isopropylthioxanthone hexafluoroantimonate, 7-[di(p-toluyl)sulfonio]-2-isopropyltetrakis(pentafluorophenyl)borate, phenylcarbonyl-4′-diphenylsulfonio-diphenylsulfide-hexafluorophosphate, phenylcarbonyl-4′-diphenylsulfonio-diphenylsulfide-hexafluoroantimonate, 4-tert-butylphenylcarbonyl-4′-diphenylsulfonio-diphenylsulfide-hexafluorophosphate, 4-tert-butylphenylcarbonyl-4′-diphenylsulfonio-diphenylsulfide-hexafluoroantimonate,4-tert-butylphenylcarbonyl-4′-diphenylsulfonio-diphenylsulfide-tetrakis(pentafluorophenyl)borate, 4-(phenylthio)phenyldiphenylsulfonium hexafluoroantimonate, 4-(phenylthio)phenyldiphenylsulfonium hexafluorophosphate, 4-{4-(2-chlorobenzoyl)phenylthio}phenylbis(4-fluorophenyl)sulfonium hexafluoroantimonate, a halide of thiophenyldiphenylsulfonium hexafluoroantimonate, 4,4′,4″-tri(β-hydroxyethoxyphenyl)sulfonium hexafluoroantimonate, 4,4′-bis[diphenylsulfonio]diphenylsulfide-bishexafluoroantimonate, diphenyl[4-(phenylthio)phenyl]sulfonium trifluorotrispentafluoroethyl phosphate, tris[4-(4-acetylphenylsulfanyl)phenyl]sulfonium tris[(trifluoromethyl)sulfonyl]methanide, salts in which the cation portion is 4-(phenylthio)phenyldiphenylsulfonium and the anion portion is a phosphorus-based anion to which fluorine and a perfluoroalkyl group are added, and the like.

Examples of the iodonium salt compounds include diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, (tricumyl)iodonium tetrakis(pentafluorophenyl)borate, and the like.

Examples of the phosphonium salt compounds include tri-n-butyl(2,5-dihydroxyphenyl)phosphonium bromide, hexadecyltributylphosphonium chloride, and the like.

Examples of the ammonium salt compounds include benzyltrimethylammonium chloride, phenyltributylammonium chloride, benzyltrimethylammonium bromide, and the like.

A single type of the photocationic polymerization initiator can be used, or two or more types of the photocationic polymerization initiator can be combined and used.

A commercially available product can be used as the photocationic polymerization initiator. Examples of the commercially available product include Cyracure UVI-6970, Cyracure UVI-6974, Cyracure UVI-6990, and Cyracure UVI-950 (manufactured by Union Carbide Corporation); Irgacure 250, Irgacure 261, and Irgacure 264 (manufactured by Ciba Specialty Chemicals); SP-150, SP-151, SP-170, and Optomer SP-171 (manufactured by ADEKA); CG-24-61 (manufactured by Ciba Specialty Chemicals); DAICAT II (manufactured by Daicel); UVAC1590 and UVAC1591 (manufactured by Daicel-Cytec Co., Ltd.); CI-2064, CI-2639, CI-2624, CI-2481, CI-2734, CI-2855, CI-2823, CI-2758, and CIT-1682 (manufactured by Nippon Soda Co., Ltd.); PI-2074 (manufactured by Rhodia); FFC509 (manufactured by 3M); BBI-102, BBI-101, BBI-103, MPI-103, TPS-103, MDS-103, DTS-103, NAT-103, and NDS-103 (manufactured by Midori Kagaku Co., Ltd.); CD-1010, CD-1011, and CD-1012 (manufactured by Sartomer); CPI-100P, CPI-101A, CPI-200K, and CPI-310B (manufactured by San-Apro Co., Ltd.); San-Aid SI-60, San-Aid SI-80, San-Aid SI-100, San-Aid SI-110, and San-Aid SI-150 (manufactured by Sanshin Chemical Industry Co., Ltd.); and the like.

A content of the photocationic polymerization initiator relative to 100 parts by mass of the cationic polymerizable compound is typically from 0.1 to 10 parts by mass, is preferably from 0.3 to 8 parts by mass, and is more preferably from 0.5 to 6 parts by mass.

The curable composition may contain components other than the cationic polymerizable compound and the photocationic polymerization initiator. Examples of the components other than the cationic polymerizable compound and the photocationic polymerization initiator include binder resins, tackifiers, silane coupling agents, and the like.

By using a curable composition containing a binder resin, a curable composition layer having excellent temporary fixing properties can be formed.

Specifically, the fluidity of the curable composition decreases as a result of adding the binder resin and, as such, the curable composition layer formed using this curable composition easily holds a certain shape even before curing, and shifting of the conductive linear bodies and the electrodes when placing the conductive linear bodies and the electrodes is suppressed.

When the curable composition contains the binder resin, a content of the binder resin is preferably from 15 to 75 mass%, more preferably from 25 to 70 mass%, and even more preferably from 30 to 65 mass% with respect to all components, except the solvent, of the curable composition.

Examples of the binder resin include phenoxy resin and modified polyolefin resin.

Since obtaining a cured layer having more a suitable storage modulus is easier, phenoxy resin is preferable as the binder resin.

The phenoxy resin is a polymer whose main chain is a polyaddition structure of an aromatic diol and an aromatic diglycidyl ether.

Examples of the phenoxy resin include, depending on the type of main chain skeleton, bisphenol A type phenoxy resin, bisphenol F type phenoxy resin, bisphenol A-bisphenol F type phenoxy resin, bisphenol E type phenoxy resin, and the like.

The phenoxy resin can be obtained by a reaction of bisphenol or a biphenol compound with an epihalohydrin such as epichlorohydrin, or a reaction of a bisphenol or a biphenol compound with a liquid epoxy resin.

A single type of the phenoxy resin can be used, or two or more types of the phenoxy resin can be combined and used.

A commercially available product can be used as the phenoxy resin. Examples of the commercially available product include PKHC, PKHH, and PKHJ (trade names, all manufactured by Tomoe Engineering Co.); Epicoat 4250, Epicote 1255HX30, and Epicote 5580BPX40 (trade names, all manufactured by Nippon Kayaku Co., Ltd.); YP-50, YP50S, YP-55, and YP-70 (trade names, all manufactured by Nippon Steel Chemical & Material Co. Ltd.); JER 1256, 4250, YX6954BH30, YX7200B35, and YL7290BH30 (trade names, all manufactured by Mitsubishi Chemical Corporation); and the like.

A weight average molecular weight (Mw) of the phenoxy resin is typically from 10,000 to 200,000, is preferably from 20,000 to 100,000, and is more preferably from 30,000 to 80,000. As a result of the weight average molecular weight of the phenoxy resin being in these ranges, it is easier to obtain a curable composition layer with excellent temporary fixing properties.

Note that, in the present specification, when the phenoxy resin has an epoxy group, a phenoxy resin having a weight average molecular weight (Mw) of 10,000 or less is set as the “compound having a cyclic ether group” described above, and a phenoxy resin having a weight average molecular weight (Mw) greater than 10,000 is set as the phenoxy resin.

The weight average molecular weight (Mw) of the phenoxy resin can be obtained as a standard polystyrene conversion value by performing gel permeation chromatography (GPC) using tetrahydrofuran (THF) as a solvent.

The storage modulus of the curable composition can be made easier to adjust and the temporary fixing properties of the curable composition layer can be enhanced by adding a tackifier to the curable composition.

Examples of the tackifier include rosin-based resins such as rosin resins, rosin ester resins, and rosin-modified phenolic resins; hydrogenated rosin-based resins obtained by hydrogenating these rosin-based resins; terpene-based resins such as terpene resins, aromatic modified terpene resins, and terpene-phenolic resins; hydrogenated terpene-based resins obtained by hydrogenating these terpene-based resins; styrene-based resins such as α-methylstyrene homopolymer resin, α-methylstyrene/styrene copolymer resin, styrene monomer/aliphatic monomer copolymer resin, styrene monomer/α-methylstyrene/aliphatic monomer copolymer resin, styrene-based monomer homopolymerization resin, styrene-based monomer/aromatic monomer copolymerization-based resin, and the like; hydrogenated styrene resins obtained by hydrogenating these styrene-based resins; C5-based petroleum resins obtained by copolymerizing C5 fractions such as pentene, isoprene, piperine, 1,3-pentadiene, and the like produced by thermal decomposition of petroleum naphtha, and hydrogenated petroleum resins of these C5-based petroleum resins; C9-based petroleum resins obtained by copolymerizing C9 fractions such as indene, vinyltoluene, and the like produced by thermal decomposition of petroleum naphtha, and hydrogenated petroleum resins of these C9-based petroleum resins; and the like. Among these, the styrene-based resins are preferable, and the styrene monomer/aliphatic monomer copolymer resin is more preferable.

A single type of the tackifier can be used, or two or more types of the tackifier can be combined and used.

A commercially available product can be used as the tackifier. Examples of the commercially available product include terpene-based resins such as YS resin P, A series, and Clearon (registered trademark) P series (manufactured by Yasuhara Chemical Co., Ltd.), Picolite A, and C series (manufactured by PINOVA), and the like; aliphatic petroleum-based resins such as Quinton (registered trademark) A, B, R, and CX series (manufactured by Zeon Corporation), and the like; styrene-based resins such as FTR (registered trademark) (manufactured by Mitsui Chemicals), and the like; alicyclic petroleum-based resins such as Alcon P and M series (manufactured by Arakawa Chemical Industries, Ltd.), ESCOREZ (registered trademark) series (manufactured by ExxonMobil Chemical Corporation), EASTOTAC (registered trademark) series (manufactured by Eastman Chemical Company), IMARV (registered trademark) series (manufactured by Idemitsu Kosan Co., Ltd.), and the like; ester-based resins such as Foral series (manufactured by PINOVA), Pencel (registered trademark) A series, Ester Gum, Super Ester, Pine Crystal (registered trademark) (manufactured by Arakawa Chemical Industries, Ltd.), and the like; and the like.

From the perspective of imparting excellent tackiness, a weight average molecular weight (Mw) of the tackifier is preferably from 100 to 10,000, and is more preferably from 500 to 5,000.

From the perspective of imparting excellent tackiness, a softening point of the tackifier is preferably from 50 to 160° C., is more preferably from 60 to 140° C., and is even more preferably from 70 to 130° C.

A content of the tackifier is not particularly limited, and can be appropriately determined in accordance with the purpose.

The forming of a cured layer with excellent adhesion strength is facilitated by adding a silane coupling agent to the curable composition.

Examples of the silane coupling agent include silane coupling agents having a (meth)acryloyl group such as 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, and the like; silane coupling agents having a vinyl group such as vinyltrimethoxysilane, vinyltriethoxysilane, dimethoxymethylvinylsilane, diethoxymethylvinylsilane, trichlorovinylsilane, vinyltris(2-methoxyethoxy)silane, and the like; silane coupling agents having an epoxy group such as 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, and the like; silane coupling agents having a styryl group such as p-styryltrimethoxysilane, p-styryltriethoxysilane, and the like; silane coupling agents having an amino group such as N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethylbutylidene) propylamine, N-phenyl-3-aminopropyltrimethoxysilane, a hydrochloride of N-(vinylbenzyl)-2-aminoethyl-3-aminopropyltrimethoxysilane, and the like; silane coupling agents having a ureido group such as 3-ureidopropyltrimethoxysilane and 3-ureidopropyltriethoxysilane, and the like; silane coupling agents having a hydrogen atom such as 3-chloropropyltrimethoxysilane, 3-chloropropyltriethoxysilane, and the like; silane coupling agents having a mercapto group such as 3-mercaptopropylmethyldimethoxysilane, 3-mercaptopropyltrimethoxysilane, and the like; silane coupling agents having a sulfide group such as bis(trimethoxysilylpropyl)tetrasulfide, bis(triethoxysilylpropyl)tetrasulfide, and the like; silane coupling agents having an isocyanate group such as 3-isocyanatopropyltrimethoxysilane, 3-isocyanatopropyltriethoxysilane, and the like; silane coupling agents having an allyl group such as allyltrichlorosilane, allyltriethoxysilane, allyltrimethoxysilane, and the like; silane coupling agents having a hydroxyl group such as 3-hydroxypropyltrimethoxysilane, 3-hydroxypropyltriethoxysilane, and the like; and the like.

A single type of the silane coupling agent can be used, or two or more types of the silane coupling agent can be combined and used.

A content of the silane coupling agent is not particularly limited, and can be appropriately determined in accordance with the purpose thereof.

The curable composition may contain additives such as antistatic agents, stabilizers, antioxidants, plasticizers, lubricants, color pigments, and the like in ranges that do not inhibit the effects of the present disclosure. Contents of these additives can be appropriately determined in accordance with the purpose thereof.

### Conductive Linear Bodies

The conductive linear bodies of the conductive structure of the present disclosure are linear members that are conductive. When using the conductive structure of the present disclosure as the heat-generating element of a heat generator, the conductive linear bodies are members that generate heat.

The conductive linear bodies may have a straight line shape, or may have a wave shape such as that of a sine wave, a square wave, a triangle wave, a sawtooth wave, or the like.

The conductive linear bodies preferably have a wave shape because defects such as disconnections are less likely to occur when bending or stretching the conductive linear bodies.

The shape of a cross-section of each of the conductive linear bodies is not particularly limited. Examples of the shape of the cross-section of each of the conductive linear bodies include a circular shape, an elliptical shape, a flat shape, a polygonal shape, and the like.

Since the fixing by the cured layer will be more stable, the shape of the cross-section of each of the conductive linear bodies is preferably a circular shape or an elliptical shape.

When the shape of the cross-section of each of the conductive linear bodies is a circular shape, a diameter of each of the conductive linear bodies 21 is preferably from 5 to 75 µm, is more preferably from 8 to 60 µm, and is even more preferably from 12 to 40 µm.

When the shape of the cross-section of each of the conductive linear bodies is an elliptical shape, the long diameter is preferably in the same range as the diameter described above.

The conductive linear bodies have appropriate resistance, and heat generation efficiency thereof is enhanced as a result of each of the conductive linear bodies having the thickness described above.

The diameter and the like of each of the conductive linear bodies can be obtained by observing the conductive linear bodies using a digital microscope.

A volume resistivity of each of the conductive linear bodies is preferably from 1.0×10⁻⁹ Ω·m to 1.0×10⁻³ Ω·m, and more preferably 1.0×10⁻⁸ Ω·m to 1.0×10⁻⁴ Ω·m.

A conductive structure suitable as a heat-generating element can be more easily obtained as a result of the volume resistivity of each of the conductive linear bodies being in these ranges.

The volume resistivity of each of the conductive linear bodies is a known value at 25° C., and is a value noted in Chemistry Handbook (Fundamentals) Revised 4th Edition (editor: The Chemical Society of Japan). Values of volume resistivity for alloys not noted in the Chemistry Handbook are disclosed by the manufacturers of those alloys.

Examples of the conductive linear bodies include a linear body including a metal wire, a linear body including a carbon nanotube, a linear body obtained by applying a conductive coating to string, and the like.

The linear body including a metal wire (hereinafter also referred to as “metal wire linear body”) may be a linear body formed from one metal wire, or may be a linear body obtained by twisting a plurality of metal wires. Additionally, the metal wire linear body may be a linear body that includes a core wire formed from a first metal, and a metal film that is provided on the outside of the core wire and that is made from a second metal different from the first metal.

Examples of the metal forming the metal wire include metals such as copper, aluminum, tungsten, iron, molybdenum, nickel, titanium, silver, gold, and the like; and alloys containing two or more metals (for example, steel such as stainless steel or carbon steel, brass, phosphor bronze, zirconium copper alloy, beryllium copper, iron nickel, nichrome, nickel titanium, kanthal, hastelloy, and rhenium tungsten, and the like).

The metal wire may have a surface that is coated with a carbon material.

Examples of the carbon material coating the metal wire include amorphous carbons (for example, carbon black, activated carbon, hard carbon, soft carbon, mesoporous carbon, carbon fiber, and the like), graphite, fullerene, graphene, carbon nanotube, and the like.

The linear body including carbon nanotubes (hereinafter also referred to as “carbon nanotube linear body”) is a linear body that includes carbon nanotubes as a conductive material.

Examples of the carbon nanotube linear body include bodies obtained by drawing carbon nanotubes from an end of a carbon nanotube forest (a grown form of a plurality of carbon nanotubes grown on a substrate so that the carbon nanotubes are oriented in a vertical direction with respect to the substrate; sometimes referred to as an “array”) to form sheets, bundling the drawn carbon nanotube sheets, and then spinning the bundle of carbon nanotubes.

According to this manufacturing method, carbon nanotube linear bodies with high purity can be obtained.

Additionally, in this manufacturing method, ribbon-shaped carbon nanotube linear bodies are obtained when the carbon nanotubes are not twisted in the spinning process, and string-shaped linear bodies are obtained when the carbon nanotubes are twisted in the process. The ribbon-shaped carbon nanotube linear bodies are linear bodies having carbon nanotubes that are not twisted.

The carbon nanotube linear bodies can also be obtained by a method such as spinning carbon nanotubes from a dispersion liquid of the carbon nanotubes. The carbon nanotube linear bodies can be manufactured by the spinning method disclosed in, for example, U.S. Pat. Application Publication No. 2013/0251619 (Japanese Patent Application Publication No. 2012-126635).

The carbon nanotube linear bodies may be linear bodies in which two or more carbon nanotube linear bodies are woven together. The carbon nanotube linear bodies also may be linear bodies including carbon nanotubes in combination with another conductive material (hereinafter also referred to as “composite linear bodies”).

Examples of the composite linear bodies include: (1) a composite linear body obtained by depositing an elemental metal or metal alloy on a surface of a forest, sheets or a bundle of carbon nanotubes, or a spun linear body through a method such as vapor deposition, ion plating, sputtering or wet plating in the process of manufacturing a carbon nanotube linear body obtained by drawing carbon nanotubes from an end of the carbon nanotube forest to form the sheets, bundling the drawn carbon nanotube sheets and then spinning the bundle of the carbon nanotubes; (2) a composite linear body obtained by spinning a bundle of carbon nanotubes with a linear body or composite linear body of an elemental metal or metal alloy; (3) a composite linear body obtained by weaving a carbon nanotube linear body or a carbon nanotube-containing composite linear body with a linear body or composite linear body of an elemental metal or metal alloy; and the like.

Note that, for the composite linear body described in (2) above, a metal may be deposited on the carbon nanotubes in a manner similar to the composite linear body described in (1) above. For the composite linear body described in (3) above, which is a composite linear body in which two linear bodies are woven together, three or more of carbon nanotube linear bodies, or linear bodies or composite linear bodies of an elemental metal or metal alloy may be woven together provided that at least one of linear bodies or composite linear bodies of an elemental metal or metal alloy is included therein.

Examples of the metal of the composite linear bodies include elemental metals such as gold, silver, copper, iron, aluminum, nickel, chrome, tin, zinc, and the like; and alloys containing at least one of these elemental metals (for example, a copper-nickel-phosphorus alloy, a copper-iron-phosphorus-zinc alloy, and the like).

Examples of the string of the linear body obtained by applying a conductive coating to a string include strings spun from a resin such as a nylon resin or polyester resin, and the like.

Examples of the conductive coating include metal coatings, conductive polymer coatings, carbon material coatings, and the like. The conductive coating can be formed by plating, vapor deposition, or the like. With the linear bodies obtained by applying the conductive coating to the string, the flexibility of the strings is maintained and, at the same time, excellent conductivity is obtained.

Among the conductive linear bodies, the metal wire linear body is preferable.

A conductive structure having a lower resistance value is easier to obtain as a result of using the metal wire linear body. Additionally, when using the conductive structure as a heat-generating element, a conductive structure including the metal wire linear body is preferable as the metal wire linear body has a tendency to heat quickly.

It is preferable that the conductive structure of the present disclosure includes two or more of the conductive linear bodies. Furthermore, it is more preferable that a pseudo-sheet structure is formed in the conductive structure of the present disclosure by arranging two or more of the conductive linear bodies at an interval.

When using the conductive structure as a heat-generating element, the amount of heat generated by the conductive structure increases due to the pseudo-sheet structure being formed.

When the pseudo-sheet structure is formed, the interval between the conductive linear bodies is preferably from 0.1 to 100 mm, is more preferably from 1 to 80 mm, and is even more preferably from 2 to 50 mm.

Provided that the interval between the conductive linear bodies is within these ranges, the conductive linear bodies will be densely packed to some extent and, as a result, the resistance of the pseudo-sheet structure can be maintained at a low level. Additionally, when using the conductive structure as a heat-generating element, a conductive structure in which the temperature rises in a more uniform manner can be more easily obtained.

The interval between the conductive linear bodies can be obtained by observing the conductive linear bodies of the pseudo-sheet structure using a digital microscope.

### Electrodes

The electrodes of the conductive structure of the present disclosure are members for supplying current to the conductive linear bodies.

The electrodes are placed so as to directly contact the conductive linear bodies. In the conductive structure of the present disclosure, the conductive linear bodies and the electrodes are each fixed in this state by the cured layer and, as such, the conductive linear bodies and the electrodes are electrically connected to each other.

The electrodes maybe linear bodies such as metal wires or the like, or may be foil-like electrodes such as metal foil or the like.

When the electrodes are linear bodies, the electrodes may have a straight line shape, or may have a wave shape such as that of a sine wave, a square wave, a triangle wave, a sawtooth wave, or the like.

The shape of a cross-section of each of the electrodes that is a linear body is not particularly limited. Examples of the shape of the cross-section of each of the electrodes include a circular shape, an elliptical shape, a flat shape, a polygonal shape, and the like, of which the circular shape is preferable.

When the shape of the cross-section of each of the electrodes is the circular shape, a diameter of each of the electrodes is preferably 3000 µm or less, is more preferably from 5 to 2000 µm, and is even more preferably from 10 to 1500 µm.

When the electrodes are foil-like, a thickness of each of the electrodes is preferably 200 µm or less, is more preferably from 1 to 150 µm, and is even more preferably from 3 to 100 µm.

A width of each of the electrodes that are foil-like electrodes is preferably 100 mm or less, is more preferably from 0.01 to 50 mm, and is even more preferably from 0.01 to 30 mm.

Examples of the electrically conductive member forming the electrodes include metals such as copper, aluminum, tungsten, iron, molybdenum, nickel, titanium, silver, gold, and the like; and alloys containing two or more metals (for example, steel such as stainless steel and carbon steel, brass, phosphor bronze, zirconium copper alloy, beryllium copper, iron nickel, nichrome, nickel titanium, kanthal, hastelloy, and rhenium tungsten, and the like).

The electrodes may be plated with tin, zinc, silver, gold, platinum, nickel, chromium, a nickel-chromium alloy, solder, or the like.

In particular, since rises in the contact resistance between the electrodes and the conductive linear bodies can be suppressed, the electrodes are preferably plated with at least one metal selected from the group consisting of gold, platinum, palladium, silver, and copper.

### Support

The conductive structure of the present disclosure may include a support.

Note that, in the present disclosure, the term “support” is not limited to members that also exist when using the conductive structure (that is, members (so-called substrates) provided to be inseparable from the cured layer), but also includes members that exist at the time of manufacture and the time of storage of the conductive structure and are removed prior to using the conductive structure (for example, release sheets, protection sheets, process sheets, and the like).

The support has roles related to maintaining the shape of the conductive structure and enhancing impact resistance and, also, has a role of facilitating the manufacturing of the conductive structure.

For example, the conductive structure 400 illustrated in FIG. 6 can be efficiently manufactured by forming each of the cured layer 41, the conductive linear bodies 42, and the electrodes 43 on the support 44. When the first support 44 is a release sheet or the like, the conductive structure 400 can also be used as the manufacturing intermediate of the conductive structure 100 illustrated in FIG. 1.

Additionally, when the support is a high-rigidity substrate, the electrodes tend to be more firmly fixed by the cured layer. This tendency is prominent in cases in which, in an embodiment in which the conductive structure, the electrodes, and the cured layer are sandwiched by supports such as illustrated in FIGS. 7 and 11, the supports on both sides are high-rigidity substrates.

When the support is a substrate, examples of the support (the substrate) include resin films, paper sheets, metal foil, glass films, non-woven fabrics, woven fabrics, and the like.

Among these, from the perspectives of more easily obtaining a conductive structure to be used advantageously as a heat-generating element, ease of machining, and the like, a resin film or a non-woven fabric is preferable as the substrate. From the perspective of further enhancing the advantageous effects of reliably fixing the conductive linear bodies and the electrodes and reducing the contact resistance of the conductive structure, a high-rigidity material such as a resin film, a paper sheet, a metal foil, a glass film, or the like is preferable as the substrate.

Examples of the resin film include polyethylene film, polypropylene film, polybutene film, polybutadiene film, polymethylpentene film, polyvinyl chloride film, vinyl chloride copolymer film, polyethylene terephthalate film, polyethylene naphthalate film, polybutylene terephthalate film, polyurethane film, ethylene vinyl acetate copolymer film, ionomer resin film, ethylene/(meth)acrylic acid copolymer film, ethylene/(meth)acrylic acid ester copolymer film, polystyrene film, polycarbonate film, polyether ether ketone film, polyphenylene sulfide film, polyvinylidene fluoride film, polytetrafluoroethylene film, silicone film, polyimide film, and the like.

For the non-woven fabric, both short fiber non-woven fabrics and long fiber non-woven fabrics can be used in the conductive structure of the present disclosure. Examples of manufacturing methods of the non-woven fabrics include a dry method, a chemical bond method, a thermal bond method, a needle punch method, a spun lace method, a spun bond method, a melt blow method, an air through method, a fleece bond method, a stitch bond method, and the like.

From the perspective of utilizing the advantages of the curable composition containing the cationic polymerizable compound and the photocationic polymerization initiator used in the present disclosure, supports for which light transmittance at a wavelength of 365 nm is 50% or less are preferable as the first support and the second support.

That is, as described above, when using the curable composition containing the photocationic polymerization initiator, light can be irradiated on the entire surface of the curable composition layer before placing the electrodes and the supports, and the curable composition can be sufficiently cured and, as such, the conductive linear bodies and the electrodes can be firmly fixed and a conductive structure with low contact resistance can be obtained even when light does not easily transmit through the supports.

Examples of supports for which light transmittance at a wavelength of 365 nm is 50% or less include polyimide films, non-woven fabrics, and woven fabrics.

In particular, since polyimide films have excellent heat resistance, a polyimide film is suitable as a substrate when manufacturing a conductive structure to be used as a heat-generating element.

In addition, non-woven fabrics and woven fabrics are suitable as substrates when manufacturing conductive structures that have extensibility or elasticity. Breathability of the conductive structure can be easily enhanced by using a non-woven fabric or a woven fabric as the material of the substrate.

When a non-woven fabric or a woven fabric is used as the first support or the second support, the contact resistance of the conductive structure tends to be more likely to rise than when using a high-rigidity material. In the present disclosure, the electrodes are fixed by the cured layer and not by a non-curing adhesive. As such, low contact resistance is more easily maintained, even when a non-woven fabric or a woven fabric is used for the supports.

A thickness of the first support is typically from 10 to 500 µm, and is preferably from 20 to 300 µm.

A thickness of the second support is typically from 10 to 500 µm, and is preferably from 20 to 300 µm.

Additionally, supports in which a release layer is provided on the resin film described above can be suitably used as the first support and the second support when removing the first support and the second support prior to using the conductive structure.

The release layer can be formed using a known release agent.

A thickness of the release layer is not particularly limited, but is typically from 0.01 to 2.0 µm, and is preferably from 0.03 to 1.0 µm.

### Uses of Conductive Structure

The conductive structure of the present disclosure can be advantageously used as a heat-generating element (sheet-shaped heater).

Examples of uses of the heat-generating element include window defoggers, defrosters, and the like. In recent years, heaters are being used to control the temperature of batteries of electric vehicles, and thin heaters are suitable for controlling the temperatures of individual laminated cells.

Additionally, the conductive structure of the present disclosure can be used as a flat cable for electrical signal wiring and as a large area touch panel.

### Manufacturing Method for Conductive Structure

The conductive structure of the present disclosure can be efficiently manufactured by utilizing the characteristics of the curable composition containing the cationic polymerizable compound and the photocationic polymerization initiator.

Examples of the manufacturing method for the conductive structure of the present disclosure include the following manufacturing method α and manufacturing method β.

The manufacturing method α includes the following steps:
a first step of manufacturing a manufacturing intermediate including the curable composition layer that is a coating of the curable composition that contains the cationic polymerizable compound and the photocationic polymerization initiator, the conductive linear bodies temporarily fixed by the curable composition layer, and the pair of electrodes placed so as to directly contact the conductive linear bodies (step α-1);
a second step of irradiating light on the curable composition layer in the manufacturing intermediate, after the first step (step α-2); and
a third step of affixing the curable composition layer irradiated with the light to a support, after the second step (step α-3).

The step α-1 can, for example, be performed by the following method.

The support (the member that ultimately becomes the first support) is prepared, the curable composition is applied on the support, and the resulting coating is dried to form the curable composition layer.

Next, the conductive linear bodies are placed on the curable composition layer. At this time, provided that at least the upper section of the conductive linear bodies is exposed and can contact the electrodes, most of the lower section may be embedded in the curable composition layer. The curable composition layer is a layer in an uncured state but, provided that a large force is not applied, typically maintains a certain shape. Accordingly, the conductive linear bodies are temporarily fixed by contacting the curable composition layer and, as a result, the manufacturing intermediate is obtained.

When placing the conductive linear bodies such that a pseudo-sheet structure is formed, as described in the examples, the pseudo-sheet structure can be efficiently formed by winding up the conductive linear bodies using a drum.

Next, the electrodes are placed at both ends of the conductive linear bodies.

Note that, in step α-1, the manufacturing intermediate may be obtained by first placing the electrodes on the curable composition layer and, then, placing the conductive linear bodies so as to straddle the electrodes.

The step α-2 can, for example, be performed by the following method.

Ultraviolet light is irradiated on the manufacturing intermediate obtained in step α-1 to initiate the polymerization reaction of the cationic polymerizable compound.

Examples of a source of the ultraviolet light include light sources such as an ultrahigh pressure mercury lamp, a high pressure mercury lamp, a low pressure mercury lamp, a carbon arc lamp, a black light fluorescent lamp, a metal halide lamp, and the like. A wavelength range of 190 to 380 nm can be used as the wavelength of the ultraviolet light to be irradiated.

The type and amount of irradiation of the ultraviolet light can be appropriately determined on the basis of the constituent components of the sheet-like adhesive to be irradiated, the contents of the various constituent components, and the like.

The irradiation illuminance is preferably from 20 to 1000 mW/cm² and an amount of light is preferably about 50 to 3000 mJ/cm².

An amount of irradiation time is typically from 0.1 to 1,000 seconds, and is preferably about 1 to 500 seconds.

When the support prepared in step α-1 is a support for which the light transmittance at a wavelength of 365 nm is 50% or less, obstruction of the irradiation of the ultraviolet light by the support can be prevented by irradiating the ultraviolet light from the side of the curable composition layer on which the support is not provided.

Note that, before irradiating the ultraviolet light, a resin film made from a material that does not absorb ultraviolet light may be stacked on the curable composition layer to protect the curable composition layer.

The step α-3 can, for example, be performed by the following method.

The curable composition layer is adhered to the support (the member that ultimately becomes the second support) after the ultraviolet light irradiation, but before the tackiness of the curable composition layer is lost due to the curable composition layer gradually curing and changing into the cured layer.

The amount of time when the curable composition layer is adhered to the support after the ultraviolet light irradiation is not particularly limited but, typically, is from one minute to five hours, and is preferably from five to 60 minutes.

At this time, a lamination treatment may be applied to form a cured layer with excellent adhesiveness.

Examples of a method for the lamination treatment include methods using a roll laminator or a vacuum laminator; examples of the conditions of the lamination treatment include a temperature of 20 to 120° C. and a pressure of 0.2 to 5 MPa; and examples of an amount of treatment time when using a vacuum laminator include from one to 60 minutes.

In the manufacturing method α, the ultraviolet light is irradiated after the electrodes are placed. The manufacturing method α is suitable when manufacturing a conductive structure in which the electrodes are linear bodies, such as metal wires or the like.

That is, since the number of steps of the manufacturing method α is few, a conductive structure in which the electrodes are linear bodies, such as metal wires or the like, can be manufactured in a more efficient manner.

The manufacturing method β includes the following steps:
a first step of manufacturing a manufacturing intermediate including a curable composition layer that is a coating of a curable composition that contains a cationic polymerizable compound and a photocationic polymerization initiator, and a conductive linear body temporarily fixed by the curable composition layer (step β-1);
a second step of irradiating light on the curable composition layer in the manufacturing intermediate, after the first step (step β-2); and
a third step of placing a pair of electrodes on the conductive linear body so as to directly contact the conductive linear body, after the second step (step β-3); and
a fourth step of affixing the curable composition layer irradiated with the light to a support, after the third step (step β-4).

With the exception of not placing the electrodes, step β-1 can be performed by the same method as step α-1.

With the exception of using a manufacturing intermediate in which electrodes are not placed, step β-2 can be performed by the same method as step α-2.

In step β-3, the electrodes are placed at both ends of the conductive linear bodies.

Step β-4 can be performed by the same method as step α-3.

In the manufacturing method β, the electrodes are placed after the ultraviolet light is irradiated. The manufacturing method β is suitable when manufacturing a conductive structure in which the electrodes are foil-like bodies, such as metal foils or the like.

That is, when the conductive structure is manufactured using the manufacturing method α, in a case in which the electrodes are foil-like bodies, the ultraviolet light is blocked by the electrodes and there may be locations where the curing reaction is insufficient.

However, according to the manufacturing method β, the entire surface of the curable composition layer can be sufficiently cured, even when the electrodes are foil-like bodies.

### 2) Article Including the Conductive Structure, and Manufacturing Method For the Article

### Article Including the Conductive Structure

An article of the present disclosure includes the conductive structure of the present disclosure.

Examples of the article of the present disclosure include articles obtained using the curable composition, which is the forming material of the cured layer in the conductive structure, as an adhesive.

Examples of the article of the present disclosure include glass with a defogging function, an article with a defrosting function, and the like.

Manufacturing method for article including the conductive structure

The article of the present disclosure can, for example, be manufactured by a manufacturing method γ that includes the following steps:
a first step of manufacturing a manufacturing intermediate including the curable composition layer that is a coating of the curable composition that contains the cationic polymerizable compound and the photocationic polymerization initiator, the conductive linear bodies temporarily fixed by the curable composition layer, and the pair of electrodes placed so as to directly contact the conductive linear bodies (step γ-1);
a second step of irradiating light on the curable composition layer in the manufacturing intermediate, after the first step (step γ-2); and
a third step of affixing the curable composition layer irradiated with the light to an adherend article, after the second step (step γ-3).

Step γ-1 can be performed by the same method as step α-1.

Step γ-2 can be performed by the same method as step α-2.

With the exception of using the adherend article instead of the support, step γ-3 can be performed by the same method as step α-3.

Examples of the adherend article include glass products, resin products, and the like that are non-sheet-like such as planar, irregularly curved, cylindrical, columnar, prismatic, or the like.

### EXAMPLES

In the following, examples are used to describe the present disclosure in further detail. However, it should be noted that the present disclosure is not limited in any way to the following examples.

### Compounds Used in the Examples

. Compound having a cyclic ether group (A-1): Epoxy resin having an oxyalkylene group [manufactured by Mitsubishi Chemical Corporation, trade name: YX7400, cyclic ether equivalent: 440 g/eq, (liquid at 25° C.)]
. Compound having a cyclic ether group (A-2): Hydrogenated bisphenol A type epoxy resin [manufactured by Mitsubishi Chemical Corporation, trade name: YX8000, cyclic ether equivalent: 205 g/eq, liquid at 25° C.]
. Compound having a cyclic ether group (A-3): 3′,4′-epoxycyclohexylmethyl 3,4-epoxycyclohexane carboxylate [manufactured by Daicel, trade name: Celloxide 2021P, cyclic ether equivalent: 128 to 145 g/eq, liquid at 25° C.]
Photocationic polymerization initiator (B-1): 4-(Phenylthio)phenyldiphenylsulfonium hexafluorophosphate [manufactured by San-Apro Ltd., trade name: CPI-100P]
. Binder resin (C-1): Phenoxy resin [manufactured by Nippon Steel Chemical & Materials, trade name: YP70EK50]

### Manufacturing Example 1

40 parts by mass of the compound having a cyclic ether group (A-1), 40 parts by mass of the compound having a cyclic ether group (A-2), 3 parts by mass of the photocationic polymerization initiator (B-1), and 100 parts by mass of the phenoxy resin (C-1) were dissolved in methyl ethyl ketone. Thus, a curable composition 1 having a solid content concentration of 47 mass% was prepared.

### Manufacturing Example 2

80 parts by mass of the compound having a cyclic ether group (A-3), 3 parts by mass of the photocationic polymerization initiator (B-1), and 100 parts by mass of the phenoxy resin (C-1) were dissolved in methyl ethyl ketone. Thus, a curable composition 2 having a solid content concentration of 47 mass% was prepared.

### Manufacturing Example 3

An isocyanate-based cross-linking agent as a cross-linking agent was added to 100 parts by mass of an acrylic copolymer [acrylic copolymer synthesized using n-butyl acrylate/acrylic acid = 90.0/10.0 (mass ratio) as raw material monomers, weight average molecular weight (Mw): 410,000]. Thus, a non-curing adhesive composition was prepared.

### Example 1

The curable composition 1 obtained in Manufacturing Example 1 was coated on a polyimide film having a thickness of 50 µm (manufactured by Du Pont-Toray Co., Ltd., trade name: Kapton 200H, transmittance of ultraviolet rays at 365 nm: 6%), and the obtained coating was dried. Thus, a curable composition layer having a thickness of 20 µm was formed. This curable composition layer was cut into a 257 mm × 364 mm rectangle. Thus, an adhesive sheet was obtained.

Next, the obtained adhesive sheet was wound on a rubber drum member, that has an outer peripheral surface made from rubber, such that the surface of the curable composition layer faced outward and, then, both ends of the adhesive sheet were fixed with double-sided tape.

Tungsten wires (diameter: 25 µm, manufactured by Tokusai TungMoly Co., Ltd., product name: TGW-CS) wound on a bobbin were adhered to the surface of the curable composition layer of the adhesive sheet fixed to the drum member and, then, the tungsten wires were wound up by the drum member while feeding out the tungsten wires from the bobbin. At this time, the tungsten wires were wound up in spirals by moving the drum member parallel to the drum axis. After the winding of a predetermined number of wires was completed, the remaining tungsten wires were cut along the axial direction of the drum. Thus, a manufacturing intermediate 1 (wire interval: 40 mm, number of wires: 6) of the conductive structure was obtained.

Gold-plated copper wires (diameter: 150 µm, manufactured by Tokusai TungMoly Co., Ltd., product name: C1100-H AuP) as electrodes were placed on both ends of the tungsten wires of the manufacturing intermediate 1 in a direction orthogonal to the direction in which the tungsten wires extend (distance between gold-plated copper wires: 150 mm).

A release film (SP-PET381130, manufactured by Lintec Corporation) was laminated on the tungsten wires and the gold-plated copper wires to protect the curable composition layer. Thus, a manufacturing intermediate 2 was obtained.

Next, the manufacturing intermediate 2 was irradiated with ultraviolet light having a wavelength of 365 nm through the release film at an illuminance of 200 mW/cm² and an integrated light amount of 300 mJ/cm² in an environment having a temperature of 23° C. and a relative humidity of 50%.

The ultraviolet light was irradiated using a high-pressure mercury lamp, manufactured by Eye Graphics Co., Ltd. Additionally, “UVPF-Al”, manufactured by Eye Graphics Co., Ltd., was used as a light meter.

After peeling the release film of the manufacturing intermediate 2 that was irradiated with the ultraviolet light, a polyimide film (manufactured by Du Pont-Toray Co., Ltd., trade name: Kapton 200H, transmittance of ultraviolet rays at 365 nm: 6%) having a thickness of 50 µm was overlaid so as to cover the curable composition layer in which the curing reaction is progressing, and lamination treatment was performed using a vacuum laminator (manufactured by Nikko Materials, product name: V130) under the conditions of 100° C., 0.5 MPa, and 30 minutes. The obtained laminate was allowed to rest as-is for 24 hours and, as a result, a conductive structure was obtained.

Note that the transmittance of ultraviolet rays at 365 nm of the polyimide film was measured using an ultraviolet and visible light transmittance measuring device (UV-3600, manufactured by Shimadzu Corporation).

### Example 2

A conductive structure was obtained in the same manner as in Example 1, except that, in the manufacturing method of Example 1, the curable composition 2 was used instead of the curable composition 1.

### Comparative Example 1

A conductive structure was obtained in the same manner as in Example 1, except that, in the manufacturing method of Example 1, the adhesive composition obtained in Manufacturing Example 3 was used instead of the curable composition 1 and, instead of the ultraviolet light treatment and the heating/lamination treatment being performed, the ultraviolet irradiation treatment was not performed, and lamination treatment by a roll laminator was performed.

Resistance value evaluation of sheet-like conductive device

Evaluation samples were obtained by cutting the conductive structures to a width of 40 mm so as to include one tungsten wire.

Voltage of 3.0 V was applied to each of the evaluation samples using DC current, and the resistance value was calculated from the current value.

The results were recorded in Table 1.

TABLE 1

| | Resistance value (Ω) |
|---|---|
| Example 1 | 21.4 |
| Example 2 | 23.1 |
| Comparative Example 1 | 27.6 |

In Examples 1 and 2, the cured layers were formed using curable compositions containing the cationic polymerizable compound and the photocationic polymerization initiator. Moreover, although the obtained conductive structures included, on both sides, the polyimide material that has low ultraviolet light transmittance, the ultraviolet light was irradiated on the curable composition layer and the reaction was initiated in a state in which the polyimide substrate was not provided on the upper surface and, then, the lamination treatment of the polyimide substrate was performed.

According to such a method, the curable composition layer can be sufficiently cured. The cured layer formed by this method is less likely to deform and, as such, the conductive linear bodies (the tungsten wires) and the electrodes (the gold-plated copper wires) can be sufficiently fixed. As a result, with the conductive structures obtained in Examples 1 and 2, the electrical connection between the conductive linear bodies and the electrodes is maintained, and the resistance value is low.

Meanwhile, in Comparative Example 1, a non-curing adhesive is used and, consequently, the conductive linear bodies (the tungsten wires) and the electrodes (the gold-plated copper wires) cannot be sufficiently fixed, and the resistance value of the obtained conductive structure is high.

Reference Signs List

| | |
|---|---|
| 100, 200, 300, 400, 500, 600 | Conductive structure |
| 11, 21, 41, 51 | Cured layer |
| 31a, 61a | First cured layer |
| 31b, 61b | Second cured layer |
| 12, 22, 32, 42, 52, 62 | Conductive linear body |
| 13, 23, 33, 43, 53, 63 | Electrode |
| 44 | Support |
| 54a, 64a | First support |
| 54b, 64b | Second support |

1. A conductive structure, comprising:
a cured layer formed by curing a curable composition;
a conductive linear body fixed by the cured layer; and
a pair of electrodes placed so as to directly contact the conductive linear body, wherein
the curable composition contains a cationic polymerizable compound and a photocationic polymerization initiator, and
the cured layer fixes the electrodes.

2. The conductive structure according to claim 1, wherein the cationic polymerizable compound is a compound that includes a cyclic ether group.

3. The conductive structure according to claim 1, wherein the conductive linear body has a wave-like shape.

4. The conductive structure according to claim 1, wherein the conductive linear body includes a metal wire.

5. The conductive structure according to claim 1, comprising:
two or more of the conductive linear bodies, wherein
a pseudo-sheet structure is formed by arranging the two or more of the conductive linear bodies at an interval.

6. The conductive structure according to claim 1, wherein the electrodes are metal wires or metal foils.

7. The conductive structure according to claim 1, further comprising:
a first support adjacent to a side of the cured layer on which the electrodes are not provided, wherein
a light transmittance at a wavelength of 365 nm of the first support is 50% or less.

8. The conductive structure according to claim 1, further comprising:
a second support adjacent to a side of the cured layer on which the electrodes are provided, wherein
a light transmittance at a wavelength of 365 nm of the second support is 50% or less.

9. The conductive structure according to claim 7, wherein at least one of the first support or the second support is a polyimide film.

10. The conductive structure according to claim 7, wherein at least one of the first support or the second support is a non-woven fabric or a woven fabric.

11. A manufacturing method for the conductive structure according to claim 8, the manufacturing method comprising:
a first step of manufacturing a manufacturing intermediate including
a curable composition layer that is a coating of a curable composition that contains a cationic polymerizable compound and a photocationic polymerization initiator,
a conductive linear body temporarily fixed by the curable composition layer, and
a pair of electrodes placed so as to directly contact the conductive linear body;
a second step of irradiating light on the curable composition layer in the manufacturing intermediate, after the first step; and
a third step of affixing the curable composition layer irradiated with the light to a support, after the second step.

12. A manufacturing method for the conductive structure according to claim 8, the manufacturing method comprising:
a first step of manufacturing a manufacturing intermediate including
a curable composition layer that is a coating of a curable composition that contains a cationic polymerizable compound and a photocationic polymerization initiator, and
a conductive linear body temporarily fixed by the curable composition layer;
a second step of irradiating light on the curable composition layer in the manufacturing intermediate, after the first step;
a third step of placing a pair of electrodes on the conductive linear body so as to directly contact the conductive linear body, after the second step; and
a fourth step of affixing the curable composition layer irradiated with the light to a support, after the third step.

13. An article comprising:
the conductive structure according to claim 1.

14. A manufacturing method for the article according to claim 13, the manufacturing method comprising:
a first step of manufacturing a manufacturing intermediate including
a curable composition layer that is a coating of a curable composition that contains a cationic polymerizable compound and a photocationic polymerization initiator,
a conductive linear body temporarily fixed by the curable composition layer, and
a pair of electrodes placed so as to directly contact the conductive linear body;
a second step of irradiating light on the curable composition layer in the manufacturing intermediate, after the first step; and
a third step of affixing the curable composition layer irradiated with the light to an adherend article, after the second step.
